(19) United States
(12) Patent Application Publication
(10) Pub. No.: US 2011/0193392 A1
(43) Pub. Date: Aug. 11, 2011

(54) Foot Rest and Method of Improving Motor Vehicle Occupant Comfort During Extended Travel

(76) Inventor: Kristian Gane, Edmonton (CA)

(21) Appl. No.: 13/021,179

(22) Filed: Feb. 4, 2011

Related U.S. Application Data
(60) Provisional application No. 61/301,388, filed on Feb. 4, 2010.

(51) Int. Cl. B60N 2/44; A47C 16/02

(52) U.S. Cl. 297/423.4; 297/423.41

(57) ABSTRACT

A foot rest features a body presenting a downward facing bottom side for bearing against a floor of a vehicle and an upward facing top side presenting two top side sloping sections extending upwardly toward one another away from opposing ends of the body. The foot rest is placed a position in front of a vehicle's occupant seat with the opposing ends on opposite sides of an axis passing centrally through the seat in a forward direction, and the occupant rests one or both feet each on a respective one of the top side sloping sections. This fully supports the bottom of the foot, avoiding a common problem with bucket chairs, most of which have lumbar and thigh support, where the thigh and the back of the leg push the knees away from each other, tilting the feet onto their blades and leading to discomfort during long distance travel.

### CROSS REFERENCE TO RELATED APPLICATIONS

This application claims benefit under 35 U.S.C. 119(e) of U.S. Provisional Patent Application Ser. No. 61/301,388, filed Feb. 4, 2010.

### FIELD OF THE INVENTION

The present invention relates generally to foot rests, and more particularly to a footrest usable by vehicle occupants to provide improved foot comfort by using sloped surfaces to support the foot across the bottom thereof where a relatively flat floor of the vehicle would otherwise fail to do so under a tendency of the foot to roll onto its blade when the vehicle occupant is seated.

### BACKGROUND OF THE INVENTION

When a vehicle driver sits in a bucket chair, most of which have lumbar and thigh support, the thigh and the back of the leg push the knees away from each other causes the feet to rest on their blades rather than flat on the bottom of base of the foot. Sitting in this position for extended periods of time with feet not properly supported can lead to improper leg posture and lower back aching. Combined with sitting in the chair of seat of the vehicle for extended periods without stretching, this can lead to repetitive strain injury or arthritis of the back and promote muscles aches in the ankles, back, neck and shoulders. A lack of comfort can also promote driver fatigue.

### SUMMARY OF THE INVENTION

According to a first aspect of the invention there is provided a motor vehicle foot rest comprising a body presenting a downward facing bottom side and an upward facing top side, the downward facing side presenting bearing surface areas for bearing against a floor of a motor vehicle to seat the footrest thereatop and the upward facing side presenting two top side sloping sections extending upwardly toward one another away from opposing ends of the body to face upwardly away from one another.

Preferably the two top side sloping sections are each planar.

The upper ends of the two top side sloping sections may be spaced apart from one another.

The upward facing side may comprise a central section disposed between the top side sloping sections at the upper ends thereof. Preferably the central section of the upward facing side is planar.

The two top side sloping sections preferably have equal surface areas.

The footrest may be symmetric about a plane cutting centrally therethrough between the opposing ends of the body.

The body may have a trapezoidal cross section of which two non-parallel sides are equal in length and defined by the top side sections and two parallel sides of unequal length are defined by the downward facing side of the body and a remainder of the top facing side of the body between the top side sloping sections thereof.

Preferably there is provided a tether coupled to the body for selective connection to an interior feature of the motor vehicle to limit movement of the footrest.

The tether may comprise an elongate flexible member selectively configurable to form a closed loop around the interior feature of the motor vehicle. When the foot rest is used in combination with the motor vehicle, the elongate flexible member is preferably closed around a support base of a vehicle seat to secure the footrest thereto.

Preferably the tether is selectively detachable from the body.

According to a second aspect of the invention there is provided a method of improving comfort of a motor vehicle occupant during extended travel, the method comprising placing the foot rest of the first aspect of the invention upon the floor of the motor vehicle in a position in front of an occupant seat thereof with the opposing ends of the body of the foot rest on opposite sides of an axis passing centrally through the occupant seat in a forward direction of the vehicle and resting one or both feet each on a respective one of the top side sloping sections.

### BRIEF DESCRIPTION OF THE DRAWINGS

In the accompanying drawings, which illustrate an exemplary embodiment of the present invention:

FIG. 1 is a top side perspective view of a footrest according to the present invention.

FIG. 2 is a side elevational view of the footrest of FIG. 1 from a side of the footrest opposite that shown therein.

FIG. 3 is an overhead plan view of the foot rest of FIGS. 1 and 2 with a tether rope secured thereto.

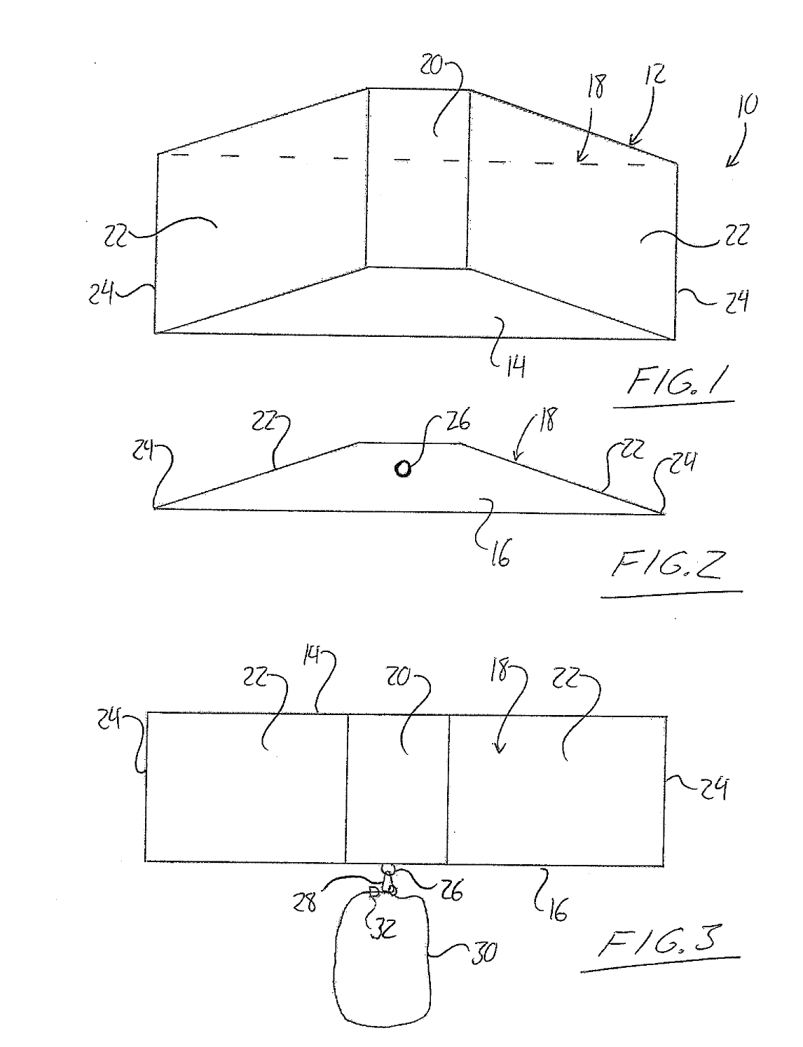

### DETAILED DESCRIPTION

The drawings show a foot rest 10 defined primarily by a solid body 12 that is rectangular in plan view and is trapezoidal in its vertical cross section, which is uniform from one vertical side wall 14 of the body 12 to an opposing parallel vertical side wall 16 in planes parallel to those of the two side walls. The solid body 12 has a planar rectangular bottom defining a longest side or base of its trapezoidal cross section. Facing upwardly away from the bottom, the top side 18 of the body 12 features three sections: a central planar rectangular top side section 20 parallel and equal in width to the rectangular bottom section; and two sloped planar rectangular top side sections 22 converging upwardly toward another from opposite ends of the rectangular bottom side to join with opposite sides of the central section 20. The sloping top side sections 22 are equally sized and sloped at equal inclination angles, but in opposite directions. The resulting body is symmetric about a central vertical plane cutting through it perpendicular to the opposing side walls 14, 16 at a central location therebetween in a direction parallel to the opposite ends 24 of the body and symmetric about a another central vertical plane cutting perpendicularly through the first central plane at central location between the opposing side walls 14, 16.

In the typical intended use of the foot rest to address the problem identified in the background section herein above, the footrest is placed on the floor of a motor vehicle in front of an occupant seat thereof, for example the driver's seat or a passenger seat depending on whether the occupant concerned is the one operating the vehicle. The foot rest is oriented to perpendicularly transverse the vertical plane of a central seat axis passing centrally through the seat back in a forward direction along which the motor vehicle is moved during straight-line driven operation thereof. As a result, the two sloped upper side sections 22 of the foot rest are presented in upward and outward facing positions on opposing sides of this central plane through the seat in order to provide foot support surfaces sloping obliquely upward toward this plane from opposite sides thereof. Accordingly, where a vehicle occupant seated in a conventional manner disposing their body's medial plane coincident with the plane cutting centrally through seat and having their feet tilted outwardly away from this central plane onto the blades or outer edges of the feet under the conditions described in the background section above would normally have their feet supported only along the blades thereof, and not across the full width of each foot as when the foot is in a properly seated flat position on a horizontal floor or ground surface, the incline of each sloping top side section of the footrest provides a respective foot support surface spanning fully across the bottom of the respective foot so that the foot is seated flat despite its non-horizontal orientation deviating from the horizontal floor surface of the vehicle.

In the illustrated embodiment, an eyebolt 26 is threaded into one of the side walls 16 of the body 12 to present an eye-defining ring at a position just laterally outward from the body 12. A spring loaded snap hook carabiner 28 passes through the eye opening of the eyebolt ring and is selectively openable to allow selective engagement and disengagement of the carabiner with closed loops formed at the opposing ends of a length of rope 30 using sleeves 32 to fix end portions of the rope in configurations folding back over themselves. Each resulting looped end of the rope can selectively be passed onto and off of the carabiner body when the gate thereof is opened by a user against the bias of the gate spring. With both ends of the rope coupled with the carabiner, the rope forms a closed loop. With one end of the rope initially disconnected, an installer of the footrest can pass the opposing free end of the rope around a suitable anchoring point or feature in the vehicle cabin and then attach this end back onto the eyebolt. The resulting closed loop of the rope around the anchoring point or feature keeps the footrest tethered to this point to limit sliding of the footrest about the vehicle floor, for example as may tend to occur under heavy braking or other conditions of relatively high deceleration or acceleration. When the footrest is used in a vehicle with a pedestal seat, which are commonly used in large scale transport vehicles such as semi-trucks, the rope can accordingly be wrapped around the seat pedestal or support base of the seat to anchor or tether the footrest to the seat to keep it in a position near thereto so as to be easily accessible by the occupant's feet and prevent sliding of the footrest sufficiently far from the seat so as to interfere with operation of the vehicle's control pedals.

It will be appreciated that other tethering configurations may alternatively be employed. For example, in place of a quick release connection between the rope and footrest body like the snap hook connection of the illustrated embodiment, one end of the rope could alternatively be permanently fastened to the body. The other end could have a biased-closed selectively openable connector thereon for either attachment to a feature in the vehicle cabin to form a single pass tether extending only once between the footrest body and the anchor selected anchor feature of the vehicle, or attachment back to the footrest body or rope after passing around a seat pedestal or other feature to form a double-pass or closed loop tether like that of the illustrated embodiment. Known connectors other than snap hook carabiners may be employed in footrest tether assemblies for connection to and later release from vehicle anchoring points. The rope may be replaced with a cable, chain, belt or other flexible elongate member, or with a more rigid device selectively openable and closeable to secure and release from a suitable anchor feature in the vehicle cabin proximate the intended foot rest position in front of the vehicle seat.

It will also be appreciated that different shapes, materials and structures may be used while still defining sloping surfaces converging upwardly away from opposing ends of the footrest toward a center thereof to selectively provide full width support to feet tilted upward and outward out of horizontal about their blades or outer edges. For example, although prototypes have been made of wood, plastics, metals or other materials may be employed, and the footrest need not necessarily have a solid-body structure in order provide sufficient support for a user's feet. The sloped areas for supporting the base of the foot need not necessarily be defined by entirely planar outer surfaces of the body, and the side sections defining the sloped feet-receiving areas need not necessarily be separated by a central section between them. However, the symmetrical body of the illustrated embodiment has advantageous in that it can be used in the described manner regardless of which side wall is facing the vehicle occupant's seat and can also be used in positions other than that detailed herein above. For example, the footrest may be moved to one side of the central seat plane and reoriented to lye parallel, not transverse, thereto, whereupon a user can then use the horizontal top side central section 20 or the sloped top side section nearest the seat and sloping upwardly away therefrom to rest the respective foot in a different position. Accordingly, the non-coplanar top side surfaces of the illustrated footrest allow a user to relocate the footrest along the vehicle floor relative to the seat's position to facilitate comfortable support in different possible foot positions and orientations.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A motor vehicle foot rest comprising a body presenting a downward facing bottom side and an upward facing top side, the downward facing side presenting bearing surface areas for bearing against a floor of a motor vehicle to seat the footrest thereatop and the upward facing side presenting two top side sloping sections extending upwardly toward one another away from opposing ends of the body to face upwardly away from one another.

2. The foot rest of claim 1 wherein the two top side sloping sections are each planar.

3. The foot rest of claim 1 wherein upper ends of the two top side sloping sections are spaced apart from one another.

4. The foot rest of claim 3 wherein the upward facing side comprises a central section disposed between the top side sloping sections.

5. The foot rest of claim 4 wherein the central section of the upward facing side is planar.

6. The foot rest of claim 1 wherein the two top side sloping sections have equal surface areas.

7. The foot rest of claim 1 wherein the footrest is symmetric about a plane cutting centrally therethrough between the opposing ends of the body.

8. The foot rest of claim 1 wherein the body has a trapezoidal cross section of which two non-parallel sides are equal in length and defined by the top side sections and two parallel sides of unequal length are defined by the downward facing side of the body and a remainder of the top facing side of the body between the top side sloping sections thereof.

9. The foot rest of claim 1 comprising a tether coupled to the body for selective connection to an interior feature of the motor vehicle to limit movement of the footrest.

10. The foot rest of claim 9 wherein the tether comprises an elongate flexible member configurable to form a closed loop around the interior feature of the motor vehicle.

11. The foot rest of claim 10 in combination with the motor vehicle, wherein the elongate flexible is closed around a support base of a vehicle seat to secure the footrest thereto.

12. The foot rest of claim 9 wherein the tether is selectively detachable from the body.

13. The foot rest of claim 1 in combination with the motor vehicle and positioned upon the floor of the motor vehicle in a position in front of an occupant seat thereof with the opposing ends of the body of the foot rest on opposite sides of an axis passing centrally through the occupant seat in a forward direction of the vehicle.

14. Method of improving comfort of a motor vehicle occupant during extended travel, the method comprising:
obtaining a foot rest having a body presenting a downward facing bottom side and an upward facing top side, the downward facing side presenting bearing surface areas for bearing against a floor of a motor vehicle to seat the footrest thereatop and the upward facing side presenting two top side sloping sections extending upwardly toward one another away from opposing ends of the body to face upwardly away from one another; and
placing the foot rest upon the floor of the motor vehicle in a position in front of an occupant seat thereof with the opposing ends of the body of the foot rest on opposite sides of an axis passing centrally through the occupant seat in a forward direction of the vehicle and resting one or both feet each on a respective one of the top side sloping sections.
